(19) United States
(12) Patent Application Publication
(10) Pub. No.: US 2007/0032199 A1
(43) Pub. Date: Feb. 8, 2007

(54) Apparatus and method for receiving channel quality information in a mobile communication system

(75) Inventors: Chung-Ryul Chang, Seoul (KR); Jang-Hoon Yang, Seongnam-si (KR); Seok-Wan Rha, Seoul (KR); Jae-Hee Cho, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/497,753

(22) Filed: Aug. 2, 2006

(30) Foreign Application Priority Data
Aug. 2, 2005 (KR) 2005-70723

(51) Int. Cl. H04B 7/00; H04B 1/00

(52) U.S. Cl. 455/69

(57) ABSTRACT

An apparatus is provided for receiving channel quality information (CQI) in a mobile communication system in which a mobile station feeds back downlink CQI over a CQI transmission channel. In the apparatus, a power correlation estimator correlating code values mapped to tiles, wherein the CQI transmission channel includes a plurality of the tiles distinguished by time and frequency resources. A maximum detector detects CQI corresponding to a code value having the maximum power correlation value among estimated power correlation values. A threshold comparator compares the detected CQI with a CQI threshold, and outputs the detected CQI as final CQI if the detected CQI is greater than or equal to the threshold.

### PRIORITY

This application claims the benefit under 35 U.S.C. § 119(a) of an application entitled “Apparatus and Method for Receiving Channel Quality Information in a Mobile Communication System” filed in the Korean Intellectual Property Office on Aug. 2, 2005 and assigned Serial No. 2005-70723, the entire contents of which are incorporated herein by reference.

### BACKGROUND OF THE INVENTION

1. Field of the Invention

The present invention relates generally to a method for receiving channel quality information in a mobile communication system, and in particular, to an apparatus and method for demodulating channel quality information being fed back by a mobile station, and estimating frequency selectivity of an uplink channel.

2. Description of the Related Art

In the 4^{th} generation (4G) communication system, active research is being conducted to provide services having various Qualities-of-Service (QoSs) to users at a data rate of about 100 Mbps. In particular, research into the 4G communication system is now being carried out to support high-speed services capable of guaranteeing mobility and QoS for a Broadband Wireless Access (BWA) communication system such as a wireless Local Area Network (LAN) system and a wireless Metropolitan Area Network (MAN) system. An Institute of Electrical and Electronics Engineers (IEEE) 802.16 based communication system is a typical 4G communication system.

The IEEE 802.16 communication system employs Orthogonal Frequency Division Multiplexing (OFDM)/Orthogonal Frequency Division Multiple Access (OFDMA) to support a broadband transmission network for physical channels of the wireless MAN system, and WiBro, which is a 2.3 GHz Portable Internet Service and also uses OFDM/OFDMA.

FIG. 1 is a diagram illustrating a configuration of a conventional IEEE 802.16 communication system. Referring to FIG. 1, the IEEE 802.16 communication system has a multicell structure of a cell 100 and a cell 150, and includes a base station (BS) 110 for managing the cell 100, a BS 140 for managing the cell 150, and a plurality of mobile stations (MSs) 111, 113, 130, 151 and 153. Signal exchanges between the BSs 110 and 140 and the MSs 111, 113, 130, 151 and 153 are achieved using OFDM/OFDMA.

OFDMA can be defined as a 2-dimensional access scheme obtained by combining time division access technology with frequency division access technology. When data is transmitted using OFDMA, each OFDMA symbol is transmitted over a predetermined subchannel by a plurality of subcarriers. Herein, the subchannel is a resource allocation unit composed of at least one subcarrier. A frame used in a communication system employing OFDMA (hereinafter OFDMA communication system) is composed of a plurality of OFDMA symbols. That is, one OFDMA symbol is composed of a plurality of subchannels.

In the mobile communication system, a signal transmitted by a transmitter arrives at a receiver experiencing multiple paths while passing through the air and peripheral media. A frequency domain of the signal passing through the multipath channel has a frequency selectivity characteristic rather than a flat characteristic over the full frequency band. In addition, the multipath channel has a time-varying characteristic according to the velocity of the MS.

The frame can be divided into a downlink interval and an uplink interval by time. Accordingly, if time-varying rates of the downlink wireless channel and the uplink wireless channel are sufficiently low, the channel states of the downlink wireless channel and the uplink wireless channel are equal to each other. The symmetry of the uplink and downlink channels is a key feature that should be taken into account in applying Adaptive Modulation and Coding (AMC) in the mobile communication system.

That is, if an MS periodically transmits downlink Channel Quality Information (CQI) over a previously allocated CQI channel (CQICH), a BS demodulates the CQI and applies an AMC scheme appropriate for a channel environment of the MS.

A detailed description will now be made of a method for applying the AMC scheme. The IEEE 802.16 communication system uses various schemes to support high-speed data transmission, and one of them is the AMC scheme. The AMC scheme refers to a data transmission scheme for adaptively determining a modulation scheme and a coding scheme according to channel state between a BS and an MS, thereby improving the entire cell utilization. The AMC scheme has a plurality of modulation schemes and a plurality of coding schemes, and modulates and encodes a channel signal with a combination of the modulation and coding schemes.

Commonly, each of the combinations of the modulation and coding schemes is referred to as a Modulation and Coding Scheme (MCS) and a plurality of MCSs of level 1 to level N can be defined according to the number of the MCSs. That is, the AMC scheme adaptively determines a level of the MCS according to channel state between an MS and a BS, thereby improving the entire system efficiency. Therefore, the BS can determine an MCS level of a corresponding MS considering the CQI reported by the MS. However, if the CQI reported from the MS is inaccurate, the BS allocates an inappropriate MCS level, causing a loss of wireless resources and a deterioration of system performance.

FIGS. 2A and 2B are diagrams illustrating a structure of a CQICH defined in a conventional IEEE 802.16 communication system, and a subchannel tile structure forming the CQICH, respectively.

Referring to FIG. 2A, the CQICH is composed of 6 tiles, which will be described in detail with reference to FIG. 2B. The 6 tiles are non-uniformly distributed on the frequency axis, and the 6 tiles constitute one CQICH, which is a fast feedback channel.

Referring to FIG. 2B, a subchannel tile structure defined in the IEEE 802.16 communication system is classified into Partial Usage SubChannel (PUSC) and Optional PUSC (OPUSC).

PUSC and OPUSC both have a 3-symbol length on the time axis. On the frequency axis, PUSC is composed of 4 subcarriers, and OPUSC is composed of 3 subcarriers. Therefore, one PUSC is composed of a total of 12 subcarriers, of which 4 subcarriers are pilot subcarriers and the other 8 subcarriers are data subcarriers. One OPUSC is composed of a total of 9 subcarriers, of which one subcarrier is a pilot subcarrier, and the other 8 subcarriers are data subcarriers. Positions of the pilot subcarriers are shown in FIG. 2B.

A description will now be made of a method in which an MS transmits a CQI to a BS using the CQICH.

The MS estimates a CQI of a downlink channel, maps a code value corresponding to the estimated CQI, and transmits the mapped code value to the BS using a CQICH. A bit size to be used for the CQI is determined according to the information broadcast by the BS. Bit sizes used by the MS are 4 bits and 6 bits. For the bit sizes, the possible number of CQIs transmitted by the MS is 2⁴ and 2⁶, respectively. The IEEE 802.16 standard defines codes associated with each bit value. Therefore, the MS modulates a CQI value according to the definition, maps each code value according to a mapping rule, and transmits the mapped code value to the BS. The MS sequentially allocates transmission CQIs to the CQICH from a first data subcarrier of the first symbol of the tile having the lowest order. After complete allocation to one tile, the MS allocates the CQIs to the tile having the next order in the same manner. Allocation of the pilot subcarriers is achieved using a method of allocating a pilot subcarrier in a pilot subcarrier position.

The signal with the CQI transmitted by the MS is received at the BS, passing through a wireless channel. To demodulate the received signal, the BS removes a Cyclic Prefix (CP) from the received signal. The CP is inserted in front of an OFDM or OFDMA symbol to prevent inter-symbol interference. The CP-removed signal is subject to Fast Fourier Transform (FFT), channel-estimation, channel compensation, and Maximum Likelihood (ML) detection processes, and then is demodulated into the original CQI transmitted by the MS. The processes of performing channel compensation according to channel estimation and of performing ML detection require many calculations, and should also acquire timing and frequency synchronization.

Even though the CQI transmitted by the MS is received at the BS, passing through a channel having a low Signal-to-Noise Ratio (SNR), the BS should successfully perform demodulation on the CQI. However, because the low-SNR channel has noise power greater than signal power, the synchronous demodulation scheme using the pilot signal suffers from degradation of channel estimation. The channel estimation degradation disables normal demodulation.

In addition, even though the BS conventionally demodulates the CQI transmitted through a high-frequency selectivity multipath channel, reliability of the demodulated CQI is low. As a result, it is difficult to guarantee a QoS level of the MS. Specifically, as compared with the CQI that passed through a high-frequency selectivity multipath channel, the CQI that passed through a non-frequency selectivity channel such as the Additive White Gaussian Noise (AWGN) channel can enable normal data demodulation even in the lower-SNR environment.

### SUMMARY OF THE INVENTION

It is, therefore, an object of the present invention to provide an apparatus and method for allowing a BS to efficiently perform demodulation on a low-SNR CQI in a BWA communication system.

It is another object of the present invention to provide an apparatus and method for estimating frequency selectivity for QoS satisfaction of an MS in a BWA communication system.

According to the present invention, there is provided a method for receiving channel quality information (CQI) in a mobile communication system in which a mobile station feeds back downlink CQI over a CQI transmission channel. The method includes correlating code values mapped to tiles, wherein the CQI transmission channel is composed of a plurality of the tiles distinguished by time and frequency resources, estimating power correlation values detecting CQI corresponding to a code value having a maximum power correlation value among the estimated power correlation values, estimating an average value of the power correlation values for the individual tiles and an instant variance value based on the average value, and estimating an average value of the instant variance and outputting an estimated frequency selectivity value.

According to the present invention, there is provided a method for receiving channel quality information (CQI) in a mobile communication system in which a mobile station feeds back downlink CQI over a CQI transmission channel. The method includes correlating code values mapped to subchannels, wherein the CQI transmission channel is composed of at least one subchannel distinguished by time and frequency resources, estimating power correlation values detecting CQI corresponding to a code value having a maximum power correlation value among the estimated power correlation values, estimating an average value of the power correlation values for the individual subchannels and an instant variance value based on the average value, and estimating an average value of the instant variance and outputting an estimated frequency selectivity value.

According to the present invention, there is provided an apparatus for receiving channel quality information (CQI) in a mobile communication system in which a mobile station feeds back downlink CQI over a CQI transmission channel. The apparatus includes a power correlation estimator for correlating code values mapped to tiles, wherein the CQI transmission channel is composed of a plurality of the tiles distinguished by time and frequency resources, a maxi mum detector for detecting CQI corresponding to a code value having a maximum power correlation value among estimated power correlation values, and a threshold comparator for comparing the detected CQI with a CQI threshold, and outputting the detected CQI as final CQI if the detected CQI is greater than or equal to the threshold.

According to the present invention, there is provided a second embodiment of an apparatus for receiving channel quality information (CQD in a mobile communication system in which a mobile station feeds back downlink CQI over a CQI transmission channel. The apparatus includes a power correlation estimator for performing correlation on code values mapped to subchannels, wherein the CQI transmission channel is composed of at least one subchannel distinguished by time and frequency resources, a maximum detector for detecting CQI corresponding to a code value having the maximum power correlation value among the estimated power correlation values, and a threshold comparator for comparing the detected CQI with a CQI threshold, and outputting the detected CQI as final CQI if the detected CQI is greater than or equal to the threshold.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a conventional IEEE 802.16 communication system;

FIGS. 2A and 2B are diagrams illustrating a structure of a CQICH defined in a conventional IEEE 802.16 communication system, and a subchannel tile structure forming the CQICH, respectively;

FIG. 3 is a diagram illustrating a structure of a BS receiver for demodulating a CQI in a conventional mobile communication system;

FIG. 4 is a block diagram illustrating a structure of a BS receiver with a single reception antenna in a mobile communication system according to the present invention;

FIG. 5 is a block diagram illustrating a structure of a BS receiver with two reception antennas in a BWA mobile communication system according to the present invention;

FIG. 6 is a block diagram illustrating a detailed structure of a frequency selectivity estimator in a BWA communication system according to the present invention;

FIG. 7 is a flowchart illustrating a CQI demodulation and frequency selectivity estimation process performed by a BS in a BWA communication system according to the present invention; and

FIG. 8 is a performance graph illustrating estimated frequency selectivity curves of the channels having different frequency selectivities according to the present invention.

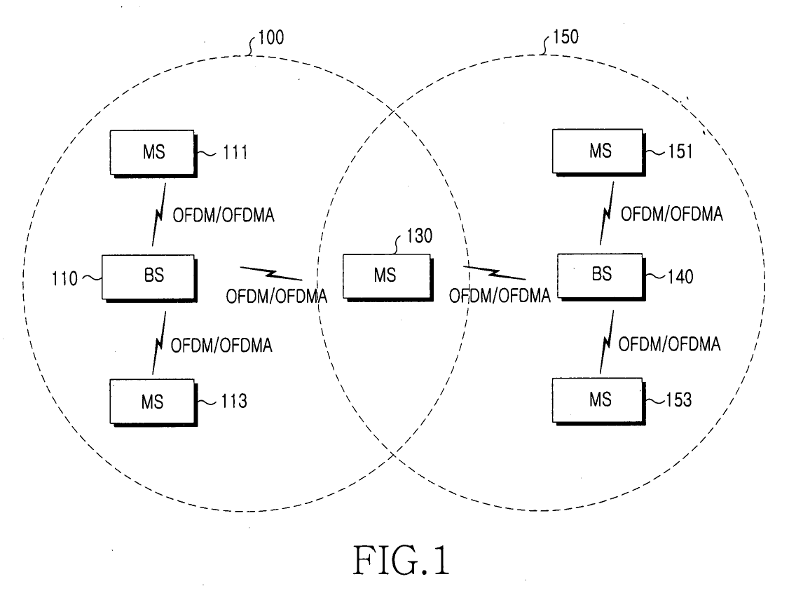

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

The present invention discloses an apparatus and method in which a base station (BS) efficiently demodulates Channel Quality Information (CQI) being fed back by a mobile station (MS) over a fast feedback channel in a mobile communication system, and estimates frequency selectivity to apply an Adaptive Modulation and Coding (AMC) scheme satisfying a Quality of Service (QoS) of the MS.

Before a description of the present invention is given, a description will be made of a process in which a BS demodulates a CQI being fed back by an MS.

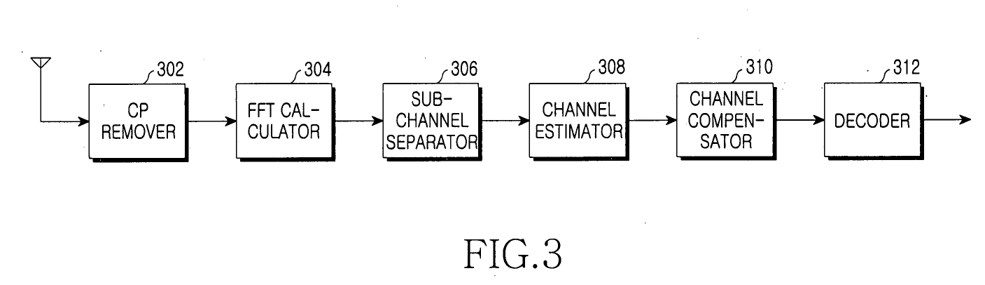

FIG. 3 is a diagram illustrating a structure of a BS receiver for demodulating a CQI in a conventional mobile communication system.

Referring to FIG. 3, the BS receiver receives a downlink CQI signal being fed back by an MS via a reception antenna. The CQI can be transmitted to the BS over a CQI channel (CQICH), which is a CQI-only feedback channel previously allocated to the MS. A Cyclic Prefix (CP) remover 302 removes a CP from the received CQI signal in the time domain, and outputs the CP-removed signal to a Fast Fourier Transform (FFT) calculator 304. The FFT calculator 304 converts the time-domain CQI signal into a frequency-domain CQI signal, and outputs the frequency-domain CQI signal to a subchannel separator 306.

The subchannel separator 306 separates subchannels corresponding to the CQICH in the frequency band, and outputs the separated subchannels to a channel estimator 308. The CQICH, while passing through a wireless channel between an MS and a BS, may suffer distortion due to any of an Additive White Gaussian Noise (AWGN), a variation in received signal power caused by fading, a shadowing phenomenon, a Doppler effect caused by the movement of an MS and a change in moving velocity of the MS, and interference from other MSs and multipath signals, causing distortion of the CQI signal. Because the original transmission signal is distorted according to the wireless channel environment before being received at the receiver, the channel estimator 308 compensates for the distorted signal and recovers the original transmission signal.

Therefore, the channel estimator 308 should estimate a frequency characteristic of the wireless channel using a pilot signal included in the CQICH. A frequency-domain CQICH value input to the channel estimator 308 can be expressed as
Y_{s,f}=H_{s,f}·X_{s,f}+N_{s,f} (1)

in which:

s: symbol index, s=0,1,2,

f: subcarrier index, f=0,1,2, . . . ,17 or 23,

H_{s,f}: ideal channel response of an f^{th} subcarrier in an s^{th} symbol,

X_{s,f}: information on a transmitted CQICH of an f^{th} subcarrier in an s^{th} symbol, and

N_{s,f}: noise characteristic of an f^{th} subcarrier in an s^{th} symbol.

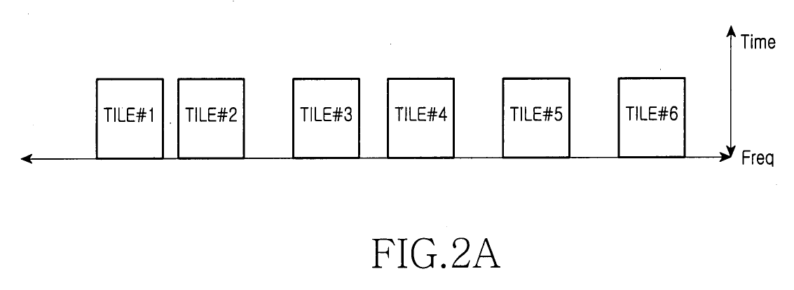

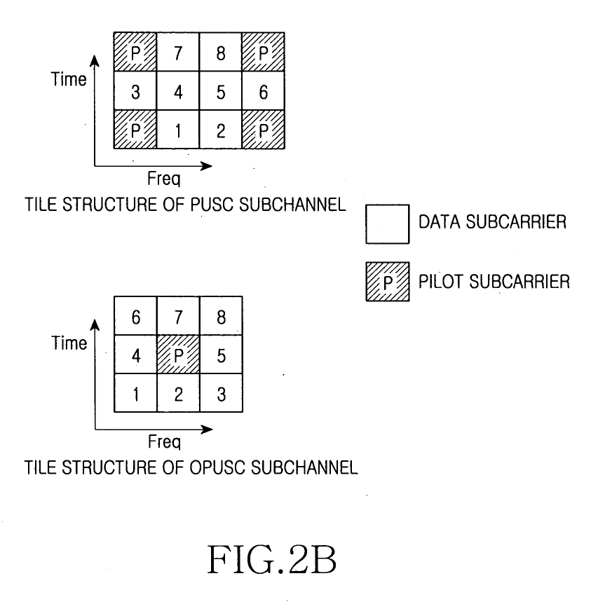

The BS uses a linear interpolation method to perform channel estimation on the CQICH signal shown in Equation (1), i.e. an Orthogonal Frequency Division Multiple Access (OFDMA) symbol. It is assumed herein that a subchannel used for the CQICH has the tile structure of Partial Usage SubChannel (PUSC) shown in FIG. 2B.

As illustrated in FIG. 2B, in the PUSC tile structure, four pilot subcarriers P are located in the corners. Because information on the pilot subcarriers P is predefined between the MS and the BS, a value channel-estimated using the pilot subcarriers can be calculated by

$${\hat{H}}_{s , f} = \frac{{Y}_{s , f}}{{P}_{s , f}} = \frac{{H}_{s , f} \cdot {P}_{s , f}}{{P}_{s , f}} + \frac{{N}_{s , f}}{{P}_{s , f}} \qquad ( 2 )$$

in which:

Ĥ_{s,f}: channel estimated value of an f^{th} subcarrier in an s^{th} symbol,

P_{s,f}: pilot information of an f^{th} subcarrier in an s^{th} symbol,

s=0,2, and

f=0,3,4,7,8,11,12,15,16,19,20,23.

A wireless channel characteristic of data subcarriers can be found by linearly interpolating a wireless channel response of the pilot subcarriers calculated using Equation (2). The linear interpolation can be performed in order of the frequency domain to the time domain, or the time domain to the frequency domain. In the following description, the linear interpolation method performs linear interpolation in the frequency domain, and then re-performs linear interpolation in the time domain. The following Equation (3) shows linear interpolation performed in the frequency domain.

$$\{ \begin{matrix}{\hat{H}}_{s , 4 \times tile + 1} = \frac{2 \times {\hat{H}}_{s , 4 \times tile} + {\hat{H}}_{s , 4 \times tile + 3}}{3} \\ {\hat{H}}_{s , 4 \times tile + 2} = \frac{{\hat{H}}_{s , 4 \times file} + 2 \times {\hat{H}}_{s , 4 \times tile + 3}}{3}\end{matrix} , tile = 0 , 1 , … 5 , s = 0 , 2 \qquad ( 3 )$$

In Equation (3), in the PUSC tile structure, each of a 0^{th} symbol and a 2^{nd} symbol includes two pilot subcarriers in one tile. In the 0^{th} symbol, 1^{st} and 4^{th} subcarriers are pilot subcarriers on the frequency axis. Further, in the 0^{th} symbol, 2^{nd} and 3^{rd} subcarriers are data subcarriers on the frequency axis. Therefore, the BS can find a channel estimated value of the data subcarriers existing in the 0^{th} and 2^{nd} symbols by linearly interpolating the channel estimated pilot subcarriers using Equation (3).

A channel estimated value of a 1^{st} symbol (s=1) can be found by linearly interpolating the frequency-domain channel estimated value calculated using Equation (3), in the time domain as shown in Equation (4) below. In the PUSC tile structure, for the 1^{st} symbol, i.e. for the symbol located in the center on the time axis, all subcarriers are data subcarriers.

$${\hat{H}}_{1 , f} = \frac{{\hat{H}}_{0 , f} + {\hat{H}}_{2 , f}}{2} , f = 0 , 1 , … 23 \qquad ( 4 )$$

The channel estimated value and the data subcarriers of the CQICH are input to a channel compensator 310.

The channel compensator 310 performs channel compensation using Equation (5) below.

$${\hat{X}}_{s , f} = \frac{{\hat{H}}_{s , f}^{*} {Y}_{s , f}}{{\vert {\hat{H}}_{s , f} \vert}^{2}} , f = 0 , 1 , … 23 , s = 0 , 1 , 2 \qquad ( 5 )$$

Equation (5) shows a channel-compensated CQICH value, which is input to a decoder 312. The decoder 312 decodes the input value using a decoding scheme corresponding to the encoding scheme used in the transmitter, and outputs a CQI.

For detection of the CQI, the decoder 312 uses a Maximum Likelihood (ML) detection scheme that compares the CQI with each of previously known CQI code values and detects the code having the minimum error. Equation (6) below is for CQI detection.

$${cqi}_{Det} = {min}_{cqi} ( {\sum }_{s = 0}^{2} {\sum }_{f = 0}^{23} {\vert {X}_{s , f} - {C}_{cqi , s , f} \vert}^{2} ) \\ cqi = 0 , 1 , , , {2}^{BitSize} - 1 ( number of transmittable cqi ' s ) \qquad ( 6 )$$

As described above, the BS should perform the channel estimation, channel compensation and ML detection processes that require many calculations to acquire the CQI fed back by the MS.

A description will now be made of a novel scheme in which a BS efficiently demodulates a low-SNR CQICH with reduced calculations, thereby accurately acquiring the CQI being fed back by an MS. In addition, the present invention proposes a scheme in which the BS estimates frequency selectivity of the CQICH to apply AMC satisfying QoS of the MS. According to this scheme, the MS can transmit a CQI with low transmission power, and the BS and the MS can reduce the number of signal retransmissions through optimal AMC setting, contributing to an increase in the entire system resource capacity and extension of the cell coverage.

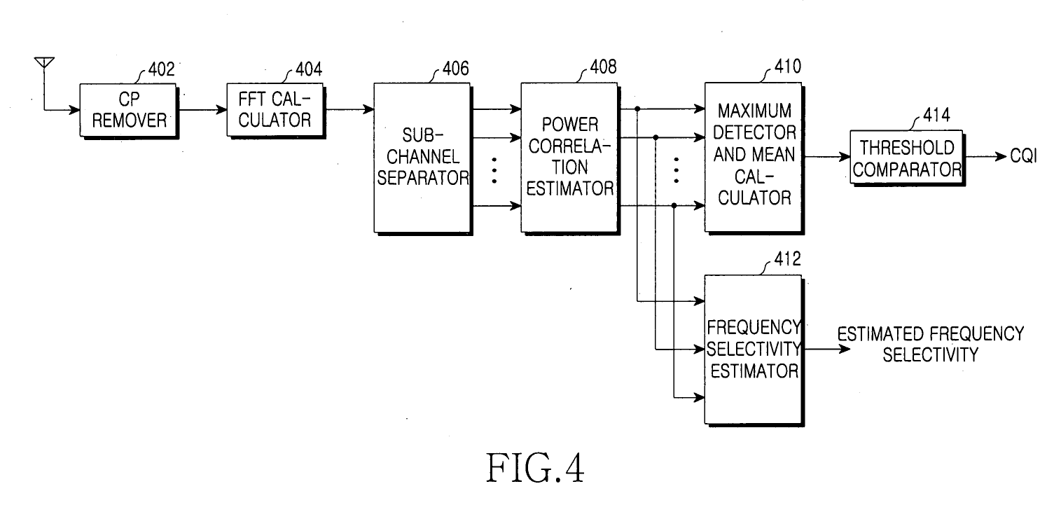

FIG. 4 is a block diagram illustrating a structure of a BS receiver with a single reception antenna in a mobile communication system according to the present invention.

Before a description of FIG. 4 is given, it should be noted that the present invention can be applied to every communication system that transmits a CQI via at least one transmission antenna and receives a CQI via at least one reception antenna.

Referring to FIG. 4, the BS receiver receives a signal using one reception antenna. A CP remover 402, an FFT calculator 404 and a subchannel separator 406 of the BS receiver are equal in operation to the CP remover 302, the FFT calculator 304 and the subchannel separator 306 of FIG. 3. The signal output from the subchannel separator 406 corresponds to a CQICH. That is, because one CQICH is constructed as shown in FIG. 2B, the subchannel separator 406 separates the signal corresponding to the CQICH. The signal output from the subchannel separator 406 is input to a power correlation estimator 408.

The power correlation estimator 408 reorders each individual tile, performs power correlation estimation on each individual tile, demodulates a CQI code for each individual tile, and outputs the results to a maximum detector and mean calculator 410, and a frequency selectivity estimator 412. The maximum detector and mean calculator 410 detects a CQI code for each individual tile using Equation (7) below, and outputs a final CQI having the maximum value to a threshold comparator 414 through summation of the detected CQI codes for the tiles. The power correlation estimator 408 can be constructed from a plurality of multipliers and accumulators, and receives the output value of the subchannel separator 406 and the CQI code value.

$$Metric ( cqi ) = {\sum }_{t = 0}^{5} \vert {\sum }_{t = 0}^{7} {Y}_{t , l} {C}_{cqi , t , l}^{*} {\vert}^{2} \\ {cqi}_{Det} = {max}_{cqi} ( Metric ( cqi ) ) \\ \{ \begin{matrix}{C}_{cqi , t , l} \text{:} CQI code of {l}^{th} subcarrier {t}^{th} tile \\ cqi = 0 , 1 , , , ( {2}^{BitSize} - 1 )\end{matrix} \qquad ( 7 )$$

The threshold comparator 414, as shown in Equation (8), compares a CQI threshold Thrᵢₙₛₜ with the final CQI max(Metric), and determines the final CQI as a final high-reliability CQI, if the final CQI is greater than or equal to the CQI threshold.
Thr_{Inst}=Mean(Metric)×Thr if (max(Metric)≧Thr _{Inst}cqi_{confirm}=cqi_{Det}else Discard (8)

In Equation (8), Thr denotes a ratio of the maximum metric value max(Metric) to a mean metric value Mean(Metric).

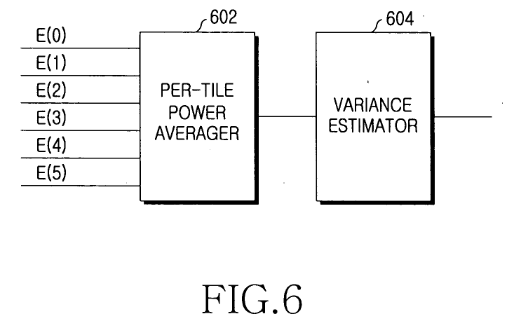

The frequency selectivity estimator 412 receives power values for the individual tiles of the modulated CQI code, calculates a mean value of the power values for the individual tiles, and performs variance estimation. An operation of the frequency selectivity estimator 412 will be described in more detail with reference to FIG. 6.

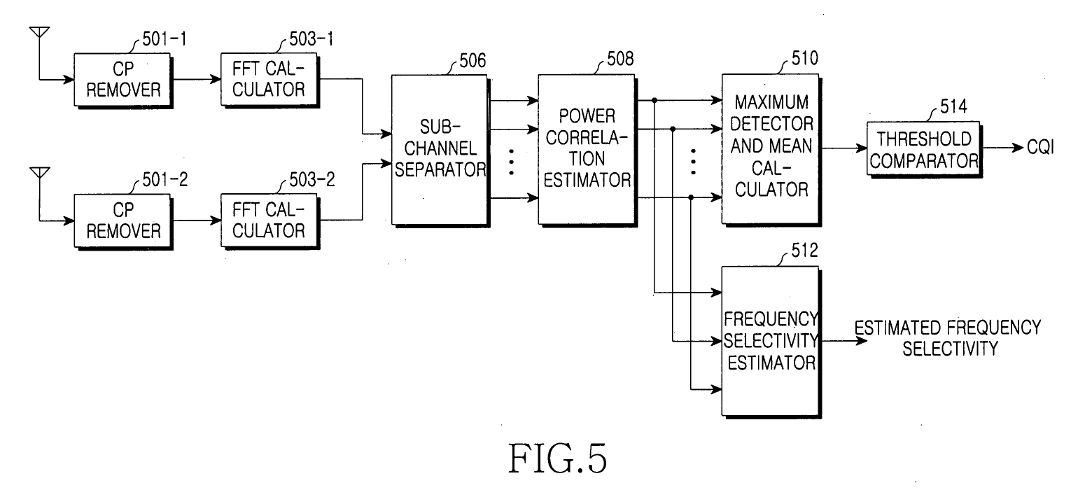

FIG. 5 is a block diagram illustrating a structure of a BS receiver with two reception antennas in a mobile communication system according to the present invention.

Referring to FIG. 5, the BS receiver, having two reception antennas, should perform CQI demodulation and frequency selectivity estimation for each of the signals received at the reception antennas. In this case, Equation (7) can be rewritten as Equation (9) below, and the other operation procedures are equal to the corresponding operation procedures of FIG. 4.

$$Metric ( cqi ) = {\sum }_{t = 0}^{5} {\sum }_{a = 0}^{1} \vert {\sum }_{t = 0}^{7} {Y}_{a , t , l} {C}_{cqi , t , l}^{*} {\vert}^{2} \\ {cqi}_{Det} = {max}_{cqi} ( Metric ( cqi ) ) \\ \{ \begin{matrix}{C}_{cqi , t , l} \text{:} CQI code \\ cqi = 0 , 1 , ⋯ , ( {2}^{BitSize} - 1 ) , number of transmittable cqi ' s\end{matrix} \qquad ( 9 )$$

where ‘a’ denotes an index of a reception antenna.

FIG. 6 is a block diagram illustrating a detailed structure of a frequency selectivity estimator in a mobile communication system according to the present invention.

Referring to FIG. 6, a frequency selectivity estimator 412 includes a per-tile power averager 602 and a variance estimator 604. The per-tile power averager 602 receives per-tile power values output from a power correlation estimator 408, i.e. demodulated CQI power values E(0) to E(5) for 6 individual tiles, and calculates an average power value defined in Equation (10) as

$$avg ( E ) = \frac{1}{6} {\sum }_{t = 0}^{5} {E}_{t} , t = 0 , 1 , 2 , 3 , 4 , 5 \qquad ( 10 )$$

An instant value P_{Inst} of a simplified variance can be found by subtracting a power value for each individual tile from the determined average power value and summing up absolute values of the subtraction results. The instant value P_{Inst} of the variance can be calculated as shown in Equation (11):

$${P}_{Inst} = {\sum }_{t = 0}^{5} \vert avg ( E ) - {E}_{t} \vert \qquad ( 11 )$$

In the low-SNR channel condition, the instant variance value calculated using Equation (11) is not highly reliable. Therefore, the present invention uses an algorithm that calculates an average value using a previous instant variance value with the use of an Infinite Impulse Response (IIR) filter. The goal of using the IIR field is to perform averaging several times to increase accuracy of the instant variance value when noise power is greater than signal power. That is, according to the statistical characteristic of the noises, an increase in number of the averaging operations reduces the noise level, guaranteeing the possibility of calculating an accurate value. Equation (12) below shows a formula used in the IIR filter.
Pₖ=(1−α)·Pₖ₋₁+α·Pₖᵢₙₛₜ (12)

In Equation (12), a ranges from 0 to 1, and denotes a weight multiplied by a previous instant variance P_{k-1 inst} value and a current instant variance value P_{k inst}.

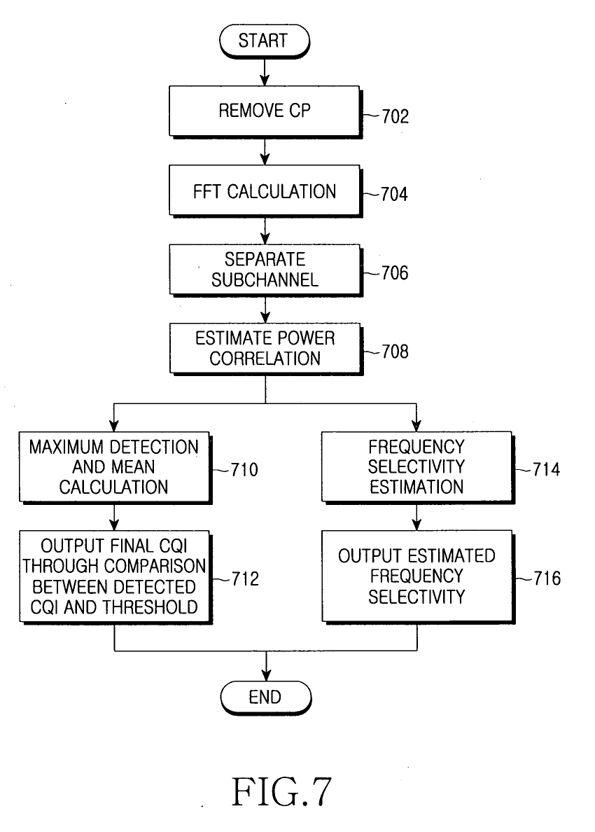

FIG. 7 is a flowchart illustrating a CQI demodulation and frequency selectivity estimation process performed by a BS in a mobile communication system according to the present invention.

Referring to FIG. 7, in step 702, the BS receives a downlink CQI signal fed back by an MS, and removes a CP from received signal in the time domain. In step 704, the BS performs FFT calculation on the CP-removed signal, to convert the time-domain signal into a frequency-domain signal. In step 706, the BS separates subchannels corresponding to a CQICH from the frequency-domain signal. In step 708, the BS performs power correlation estimation on each individual tile.

In step 710, if a demodulated maximum CQI value is greater than or equal to a threshold, the BS determines the maximum CQI value as a detected final CQI value. However, if the maximum CQI value is less than the threshold, the BS disregards the maximum CQI value. In step 712, the final CQI determined in the threshold comparison process is output with high reliability.

In step 714, the BS calculates an average power value using the CQI power value for each individual tile, calculates an instant variance value, and estimates frequency selectivity. In step 716, the BS can determine an AMC level to be allocated to an MS according to the estimated frequency selectivity, and outputs the estimated frequency selectivity value. The process of determining by the BS the MCS level according to the estimated frequency selectivity is not directly related to the present invention, so a detailed description thereof will be omitted.

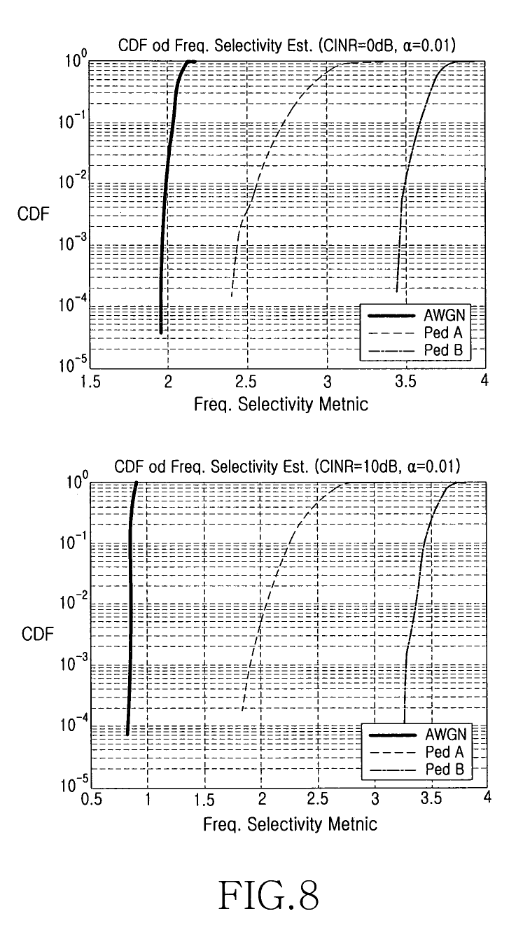

FIG. 8 is a performance graph illustrating estimated frequency selectivity curves of the channels having different frequency selectivities according to the present invention.

It can be noted from FIG. 8 that a low/non-frequency selectivity channel such as the AWGN channel, and high-frequency selectivity channel such as the pedestrian-A and pedestrian-B channels, are separated by a frequency selectivity value of about 2.2.

As can be understood from the foregoing description, in the mobile communication system according to the present invention, a BS can perform CQI demodulation with minimum calculation, and estimate frequency selectivity, guaranteeing QoS satisfaction of an MS. In addition, the BS can perform CQI demodulation even in the low-SNR channel environment, so the MS can also report a CQI at low transmission power. These advantages contribute to extension of cell coverage and an increase in cell resource capacity.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for receiving channel quality information (CQI) in a mobile communication system in which a mobile station feeds back downlink CQI over a CQI transmission channel, the apparatus comprising:
a power correlation estimator for correlating code values mapped to tiles, wherein the CQI transmission channel includes a plurality of the tiles distinguished by time and frequency resources;
a maximum detector for detecting CQI corresponding to a code value having a maximum power correlation value among estimated power correlation values; and
a threshold comparator for comparing the detected CQI with a CQI threshold, and outputting the detected CQI as final CQI if the detected CQI is greater than or equal to the threshold.

2. The apparatus of claim 1, further comprising a frequency selectivity estimator for receiving the power correlation values output from the power correlation estimator, estimating an average value of the power correlation values for the individual tiles and an instant variance value based on the average value, estimating an average value of the instant variance value, and outputting an estimated frequency selectivity value.

3. The apparatus of claim 2, wherein the frequency selectivity estimator comprises:
a per-tile power averager for averaging the power correlation values for the individual tiles; and
a variance estimator for estimating an instant variance value based on the average of the power correlation values, and estimating an average value of the instant variance value.

4. The apparatus of claim 1, further comprising:
a cyclic prefix (CP) remover for receiving a signal from the mobile station and removing a CP from the received signal;
a Fast Fourier Transform (FFT) calculator for performing FFT on the CP-removed signal; and
a subchannel separator for separating a subchannel band including the CQI from the FFT-processed signal.

5. A method for receiving channel quality information (CQI) in a mobile communication system in which a mobile station feeds back downlink CQI over a CQI transmission channel, the method comprising the steps of:
correlating code values mapped to tiles, wherein the CQI transmission channel includes a plurality of the tiles distinguished by time and frequency resources;
estimating power correlation values;
detecting CQI corresponding to a code value having a maximum power correlation value among the estimated power correlation values;
estimating an average value of the power correlation values for the individual tiles and an instant variance value based on the average value; and
estimating an average value of the instant variance and outputting an estimated frequency selectivity value.

6. The method of claim 5, further comprising the steps of:
detecting CQI corresponding to a code value having the maximum power correlation value among the estimated power correlation values;
comparing the detected CQI with a CQI threshold; and
outputting the detected CQI as final CQI if the detected CQI is greater than or equal to the threshold.

7. The method of claim 5, further comprising the steps of:
removing a cyclic prefix (CP) from a signal received from the mobile station;
performing Fast Fourier Transform (FFT) on the CP-removed signal; and
separating a subchannel band including the CQI from the FFT-processed signal.

8. An apparatus for receiving channel quality information (CQI) in a mobile communication system in which a mobile station feeds back downlink CQI over a CQI transmission channel, the apparatus comprising:
a power correlation estimator for correlating code values mapped to subchannels, wherein the CQI transmission channel includes at least one subchannel distinguished by time and frequency resources;
a maximum detector for detecting CQI corresponding to a code value having a maximum power correlation value among estimated power correlation values; and
a threshold comparator for comparing the detected CQI with a CQI threshold, and outputting the detected CQI as final CQI if the detected CQI is greater than or equal to the threshold.

9. A method for receiving channel quality information-(CQI) in a mobile communication system in which a mobile station feeds back downlink CQI over a CQI transmission channel, the method comprising the steps of:
correlating code values mapped to subchannels, wherein the CQI transmission channel includes at least one subchannel distinguished by time and frequency resources;
estimating power correlation values;
detecting CQI corresponding to a code value having a maximum power correlation value among the estimated power correlation values;
estimating an average value of the power correlation values for the individual subchannels and an instant variance value based on the average value; and
estimating an average value of the instant variance and outputting an estimated frequency selectivity value.
